(19) United States
(12) Patent Application Publication
(10) Pub. No.: US 2004/0100254 A1
(43) Pub. Date: May 27, 2004

(54) Detector arrangement

(76) Inventor: Ari Viitanen, Vantaa (FI)

Correspondence Address: SMITH-HILL AND BEDELL, 12670 N W BARNES ROAD, SUITE 104, PORTLAND, OR, 97229

(21) Appl. No.: 10/332,663

(22) PCT Filed: Jun. 15, 2001
(86) PCT No.: PCT/FI01/00567

(30) Foreign Application Priority Data
Jul. 12, 2000 (FI) 20001652

(51) Int. Cl. G01B 7/14

(52) U.S. Cl. 324/207.26; 324/207.24

(57) ABSTRACT

A detector unit for detecting the position and/or the state of movement of movable elements containing ferromagnetic material and relating especially to locking arrangements, said detector unit comprising a reed-relay (2) and permanent magnetic means (1). The reed-relay (2) is fixed to the permanent magnetic means (1) to a position, in which the magnetic flux provided by the permanent magnetic means (1) includes an essential deviation so that the reed-relay (2) is not normally switched on.

The invention relates to a detector unit, in accordance with the preamble of claim 1, for detecting the position and/or the state of movement of movable elements containing ferromagnetic material and relating especially to locking arrangements, said detector unit comprising a reed-relay and permanent magnetic means.

Electric control systems to be utilized in connection with locking require detection of the position or the state of movement of different movable units or members. In this connection it is known to make use of especially micro switches. Depending on the application, however, these require quite a lot of space and require mechanical contact. There are also different solutions in which reed-relays serve as detectors. It is known to use reed-relays especially for the detection of the position of a door or a window, whereby an electric circuit relating to the reed-relay may be connected to be part of a burglar prevention and alarm system. The basic alternatives are that the reed-relay is located immovable in the frame and a permanent magnet is in the movable part or in a door or a window and is located at the position of the reed-relay when the said part is closed, or vice versa.

The aim of the invention is to provide a novel, improved detector arrangement, which is based on the use of reed relays for detecting the position or the state of movement of movable members and which can be applied especially for different applications relating to locking technology. An aim is more closely that the detector arrangement is simple as to its construction, reliable as to its operation and advantageous as to its costs. A further aim is to provide a detector arrangement, which has a compact size and form and which can be utilized as such in several different locations of application.

The aims of the invention can be met as is disclosed in claim 1 and in the other claims. In accordance with the invention the reed-relay is fixed to the permanent magnetic means to a position, in which the magnetic flux provided by the permanent magnetic means includes an essential deviation so that the reed-relay is not normally switched on. The solution makes it possible to provide a simple and compact detector arrangement.

In an advantageous embodiment the reed-relay is located at a position between the poles of the permanent magnet, in which the magnetic flux is at its minimum.

In another embodiment the reed-relay is located at a position, in which a deviation is arranged on the magnetic flux of the permanent magnetic means so that at the said point in the permanent magnetic means there is a recess in the material, for instance a hole, a cavity or the like. Thus, the deviation must be so great in view of the surrounding magnetic flux that the reed-relay is not switched on when installed in its position.

The reed-relay is with advantage fixed directly on the surface of the permanent magnetic means for instance by gluing. The epoxy resin glue sold under the brand name Araldit, for instance, is suitable for the purpose.

In practice the permanent magnetic means comprise a somewhat flat permanent magnet preferably in the form of a rectangle, with which the reed-relay forms a compact unit which can be installed as such to different locations of installation. The arrangement requires little space and is easy to install at the location of installation. For this purpose the reed-relay is with advantage installed on the longer narrow side of the permanent magnet.

The reed-relay is with advantage connected to an electric circuit, the voltage of which is in the order of 24 V and the amperage is in the order of 0,1 A.

Hereby the need for power can be kept small without the risk of compromising the reliability of operation of the detector unit. A pulse of current resulting from the switching-on of the reed-relay can further be supplied into a control logic for providing a desired control operation.

In an advantageous practical application the detector unit is installed behind a striking plate for a door lock or the like, provided with a bolt, at the side of the frame for detecting the position of said bolt. The striking plate is then provided with a non-ferromagnetic protecting plate, to which the detector unit is fixed and which is located between the detector unit and the bolt when the bolt is inserted through an opening in the striking plate. A protecting plate of this kind has no effect on the reed-relay and thus the detector unit can be installed to be unnoticeable and it cannot be manipulated from outside.

In another practical application the detector unit is installed inside a lock case for a door lock or the like so that it detects the position of some movable element associated with the operation of the lock, for instance an auxiliary bolt or a control solenoid. Due to its compact construction and small size the detector unit according to the invention can be applied for various practical purposes.

In the following the invention is described, by way of example, with reference to the attached drawings, in which

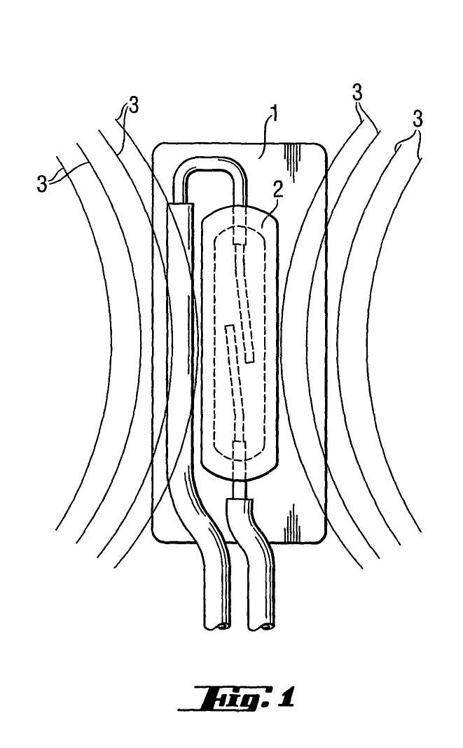

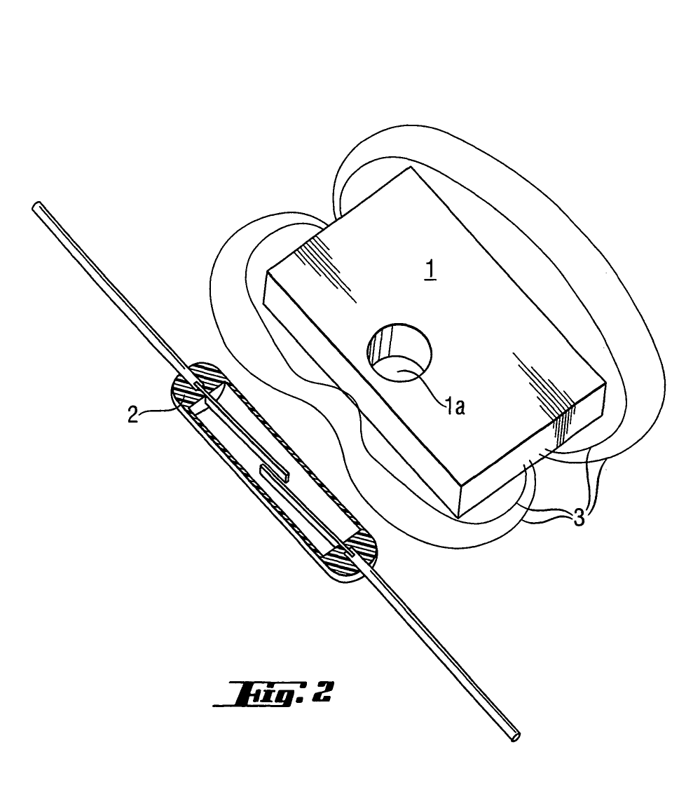

FIG. 1 shows a detector unit according to the invention as a view of principle,

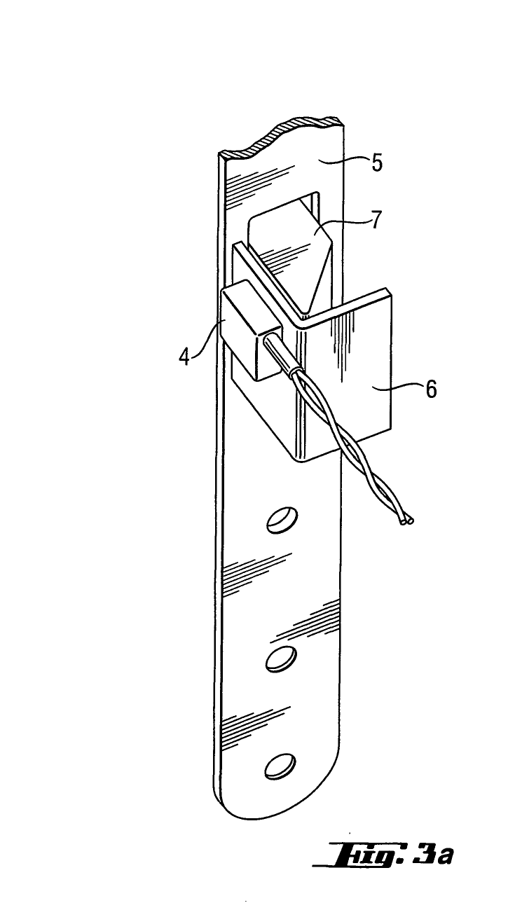

FIG. 2 shows another detector unit according to the invention as a view of principle,

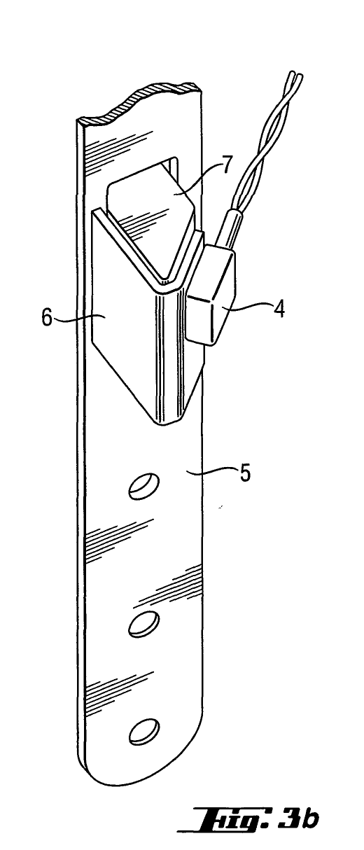

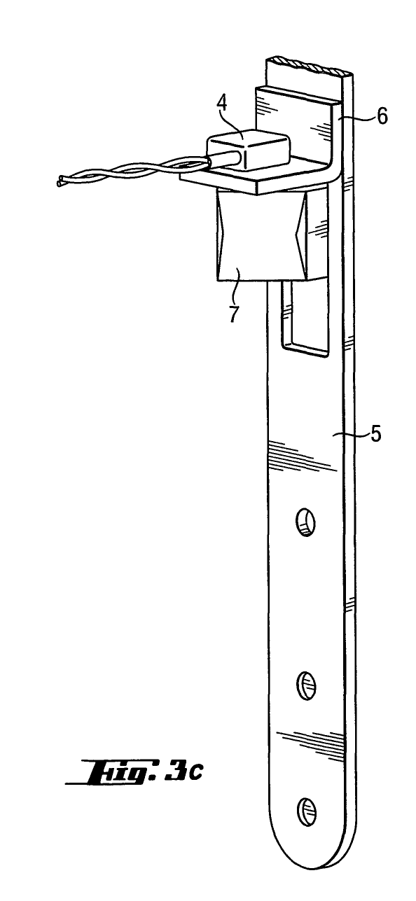

FIGS. 3a, 3b and 3c illustrate installation of a detector unit according to the invention in connection with a striking plate of a door lock,

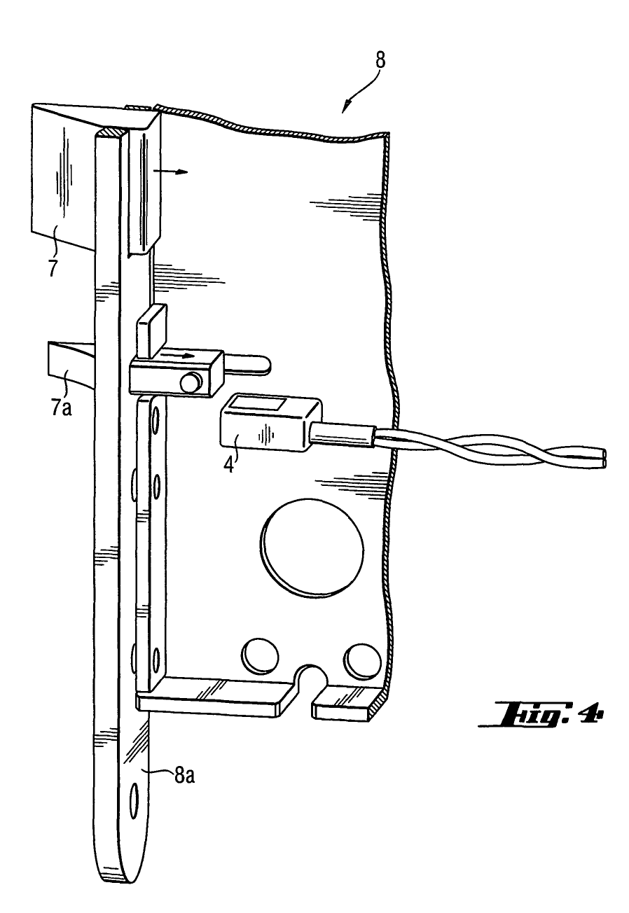

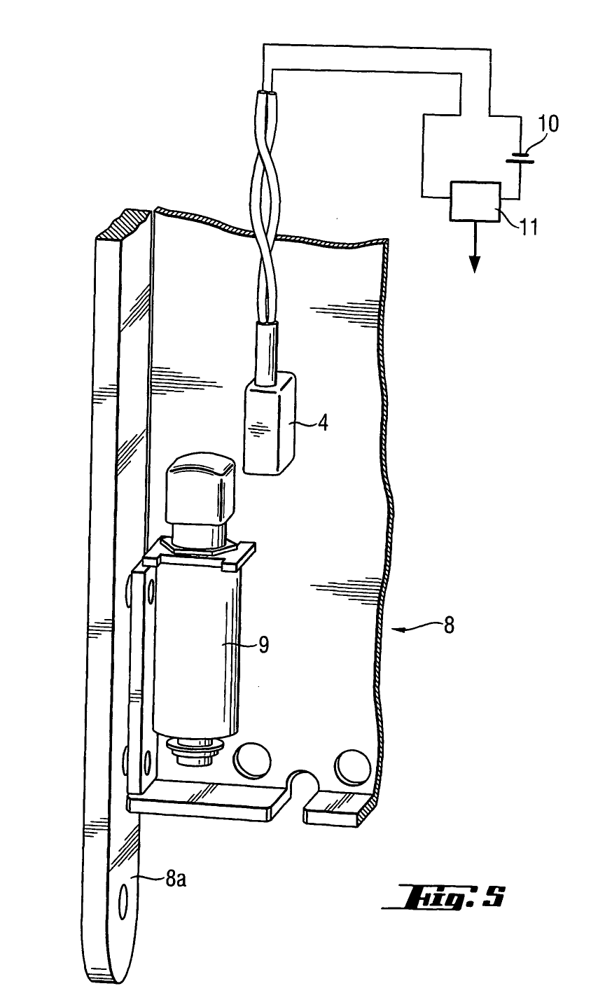

FIGS. 4 and 5 illustrate installation of a detector unit according to the invention inside a lock case for detecting the position of different movable members.

In FIGS. 1 and 2 the reference numeral 1 indicates a flat permanent magnet, on the narrow side of which there is installed a reed-relay 2. As can be seen from flux lines 3 illustrating the magnetic flux provided by the permanent magnet the location of installation for the reed-relay 2 is chosen in the arrangement according to FIG. 1 with regard to the poles of the magnet so that it is located between magnetic fields of different direction, whereby the reed-relay 2 is not switched on. Correspondingly in the arrangement of FIG. 2 there is a hole 1a made in the permanent magnet 1 causing a deviation in the magnetic flux as can be seen from the flux lines 3. In this case the reed-relay 2 is located at the position of said deviation relating to the magnetic flux. The size and location of the hole 1a or a corresponding recess, naturally, is to be selected so that also in this case the reed-relay 2 is not switched on.

The switching on of the relay occurs in each location of application only when a member containing iron or some other ferromagnetic material is moved in the vicinity of the detector unit and causes a small but sufficient change in the magnetic flux at the position of said deviation. Then the contact points of the reed-relay close, since they get under the influence of the changed magnetic field, whereby the electric circuit associated with the application in each case is closed (cf. for instance FIG. 5). Correspondingly when the member containing ferromagnetic material is moved away from the vicinity of the reed-relay 2 the contact points of the relay move into their original non-switching position.

It is important from the viewpoint of the operation of the detector that as installed the reed-relay 2 cannot move relative to the permanent magnet 1. This can be secured in a simple way by means of for instance gluing. In practice a glue suitable for the purpose is such that contain epoxy resin sold for instance under the brand name Araldit.

Since according to the invention the reed-relay 2 is fixed directly on the permanent magnet 1 and the arrangement can with advantage be implemented without electronic components, the detector unit can be made compact as to its size and form and advantageous as to its costs. A detector unit of this kind can easily be utilized in different locations of application and especially also as retrofitted.

FIGS. 3a, 3b and 3c illustrate installation of a detector unit 4 containing a permanent magnet 1 and a reed-relay 2 in connection with a striking plate 5 for a door lock. In this case the detector unit can be utilized for detecting the position of a bolt 7 of the lock and thus further the state of locking of the door. In practice a protecting plate 6 of a non-ferromagnetic material, for instance of aluminium, is fixed to the striking plate 5, to which the detector unit 4 can be fixed for instance by gluing. In this case the protecting plate 6 has no effect on the magnetic flux, so as such it does not affect the operation of the relay either.

FIGS. 4 and 5 show as a view of principle applications, in which the detector unit 4 is installed inside a lock case 8 to be mortised for instance inside a door for detecting the position of different movable members. Also in this case the installation may occur for instance by gluing. In the case of FIG. 4 the position of a so called auxiliary bolt 7a is detected. When the not-shown door is open, the auxiliary bolt 7a protrudes out from an opening in a front plate 8a of the lock case as shown in FIG. 4. Correspondingly when the door is closed the auxiliary bolt 7a can protrude only somewhat outwards, since its head hits a striking plate for the lock located in the door frame (not shown in FIG. 4). As a consequence of this the inner end of the auxiliary bolt 7a moves at the position of the detector unit 4, whereby its reed-relay is switched on. The application can thereby be utilized for detecting the position of a door without the need to place any other members or sensors in the door and/or in the door frame. The detector unit is also visually hidden and thus protected.

The application of FIG. 5 for its part shows a solution, in which the position of operation of a solenoid 9 located inside the lock case 8 can be controlled. The solenoid 9 as such may be utilized according to need for different force transmission arrangements related to the operation of the lock. For instance by means of it a force transmission connection from an operating axis to the lock bolt may be connected and disconnected. FIG. 5 shows also in principle, how the detector unit is in practice connected to an electric circuit provided with a suitable power source 10, by means of which the signal from the reed-relay can be supplied into a suitable control logic 11 for detecting the state of operation in each case and/or for providing a desired operation relating to the object location to be controlled.

The invention is not limited to the embodiments disclosed, but several modifications are feasible within the scope of the attached patent claims.

1. A detector unit for detecting the position and/or the state of movement of movable elements containing ferromagnetic material and relating to locking arrangements, said detector unit comprising a reed-relay (2) and permanent magnetic means (1), characterized in that the reed-relay (2) is fixed directly on the surface of the permanent magnetic means (1) to a position, in which the magnetic flux provided by the permanent magnetic means (1) includes an essential deviation so that the reed-relay (2) is not normally switched on.

2. A detector unit according to claim 1, characterized in that the reed-relay (2) is located at a position between the poles of the permanent magnet (1), in which the magnetic flux is at its minimum.

3. A detector unit according to claim 1 or 2, characterized in that the reed-relay (2) is located at a position, in which a deviation is arranged on the magnetic flux of the permanent magnetic means (1) so that at the said point in the permanent magnetic means (1) there is a recess in the material, for instance a hole (1a), a cavity or the like.

4. A detector unit according to any one of the preceding claims, characterized in that the reed-relay (2) is fixed on the permanent magnetic means (1) by gluing.

5. A detector unit according to any one of the preceding claims, characterized in that the permanent magnetic means (1) comprise a somewhat flat permanent magnet (1) preferably in the form of a rectangle, with which the reed-relay forms a compact unit (4), which can be installed as such to different locations of installation.

6. A detector unit according to claim 5, characterized in that the reed-relay (2) is installed on the longer narrow side of the permanent magnet (1).

7. A detector unit according to any one of the preceding claims, characterized in that the reed-relay (2) is connected to an electric circuit, the voltage of which is in the order of 24 V and the amperage is in the order of 0,1 A, and that a pulse of current resulting from the switching-on of the reed-relay (2) is arranged to be supplied into a control logic (11) for providing a desired control operation.

8. A detector unit according to any one of the preceding claims, characterized in that it is installed behind a striking plate (5) for a door lock (8) or the like, provided with a bolt (7), at the side of the frame for detecting the position of said bolt (7).

9. A detector unit according to claim 8, characterized in that the striking plate (5) is provided with a non-ferromagnetic protecting plate (6), to which the detector unit (4) is fixed and which is located between the detector unit (4) and the bolt (7) when the bolt is inserted through an opening in the striking plate (5).

10. A detector unit according to any one of the preceding claims 1-7, characterized in that it is installed inside a lock case (8) for a door lock or the like so that it detects the position of some movable element associated with the operation of the lock, for instance an auxiliary bolt (7a) or a control solenoid (9).
